(19) United States
(12) Patent Application Publication
(10) Pub. No.: US 2022/0369847 A1
(43) Pub. Date: Nov. 24, 2022

(54) COFFEE MACHINE

(71) Applicant: Melitta Europa GmbH & Co. KG, Minden (DE)

(72) Inventors: Andreas SACHTLEBEN, Minden (DE); Daniel KUTZBACH, Minden (DE)

(73) Assignee: Melitta Europa GmbH & Co. KG, Minden (DE)

(21) Appl. No.: 17/746,117

(22) Filed: May 17, 2022

(30) Foreign Application Priority Data
May 18, 2021 (DE) 10 2021 112 895.1

(51) Int. Cl. A47J 31/057; A47J 31/42

(52) U.S. Cl. CPC A47J 31/057; A47J 31/42

(57) ABSTRACT

A coffee machine has a container for coffee beans, a grinder to which coffee beans can be fed from the container, a filter holder into which ground coffee can be fed from the grinder via a shaft, and a supply device for hot water which can be introduced into the filter holder. In the shaft between the grinder and the filter holder a closing device is provided with a rotatable flap which is movable between an open and a closed position. The flap is rotatable about an axis which extends substantially parallel to a plane of the flap and has a seal arranged on the outer periphery. This allows the shaft to be effectively opened and closed.

### CROSS REFERENCE TO RELATED APPLICATIONS

Applicant claims priority under 35 U.S.C. § 119 of German Application No. 10 2021 112 895.1 filed May 18, 2021, the disclosure of which is incorporated by reference.

### BACKGROUND OF THE INVENTION

### 1. Field of the Invention

The present invention relates to a coffee machine with a container for coffee beans, a grinder to which coffee beans can be fed from the container, a filter holder into which ground coffee can be fed from the grinder via a shaft and a supply device for hot water, which can be introduced into the filter holder, a closing device being provided in the shaft between the grinder and the filter holder and having a rotatable flap which can be moved between an open position and a closed position, the flap being rotatable about an axis which runs essentially parallel to a plane of the flap.

### 2. Description of the Related Art

DE 20 2004 007 182 U1 discloses a coffee machine in which a coffee grinder is arranged above a filter holder for receiving ground coffee. Ground coffee can be conveyed from the coffee grinder through a chute into the filter holder, the chute being closable by a shielding plate. The shielding plate is biased to the closed position by a spring and is movable to an open position by a switch. This allows a certain amount of shielding to be obtained, but it is difficult to achieve a seal to the grinder because the shielding plate is moved parallel to the sealing plane, resulting in stress and wear of a sealing element at the sealing plane.

DE 20 2008 016 826 U1 also discloses a similar separating device for a coffee machine. In this separating device, a separating disk can be moved along a seal on a chute between the coffee grinder and the filter holder. Here, too, abrasion can occur due to the movement of the separating disk relative to the seal.

WO 2007/106947 discloses a coffee machine with a grinder via which ground coffee can be fed into a filter holder. A pivotable flap for closing lies against an underside of a shaft in the closed position, so that the seal is inadequate.

### SUMMARY OF THE INVENTION

It is therefore an object of the present invention to provide a coffee machine in which an improved seal is provided between a grinder and a filter holder to prevent interference with the grinder function.

This object is solved according to the invention with a coffee machine having a container for coffee beans, a grinder to which coffee beans can be fed from the container, a filter holder into which ground coffee from the grinder can be fed via a shaft, and a supply device for hot water which can be introduced into the filter holder. A closing device with a rotatable flap is provided in the shaft between the grinder and the filter holder, the flap being rotatable about an axis which is substantially parallel to a plane of the flap, an elastic seal being provided on the outer periphery of the flap. As a result, the flap does not move parallel to the plane of the flap between the open and closed positions, resulting in a grinding motion along a seal, but rather with a pivoting motion toward or away from the sealing plane to the closed position. This movement of the flap reduces wear on the sealing element and thus provides a more reliable seal.

Preferably, the plane of the flap corresponds to a sealing plane in the closed position. The sealing plane can be defined, for example, by the contact of the flap or a seal of the flap with a shaft wall. This plane is essentially parallel to the axis of rotation of the flap, although the axis can also be arranged at a smaller angle to the plane of the flap, for example <20°, in particular <10°.

Preferably, in the closed position, the flap has an upper surface that is at least partially disposed in the chute, the upper surface of the flap in the open position forming a wall portion that faces the inside of the chute. As a result, any coating of coffee grounds on the planar top surface is ejected into the chute when the flap is rotated to the open position.

In a preferred embodiment, the axis of the flap is located outside the chute. This means that only part of the flap protrudes into the chute in the closed position, in particular a part that occupies less than 50% of the surface area of the flap in plan view. This means that the actuating mechanism for the flap can be provided outside the chute, resulting in improved hygiene.

The flap is preferably rotated through an angle of between 60° and 120°, in particular 80° to 100°, between the opening and closing positions. In this case, the axis can extend in a horizontal plane in the setup position of the coffee machine, so that the flap can be transferred from a horizontal closed position to a substantially vertical open position.

Next to the chute, a downwardly open receiving chamber is preferably formed, into which the flap can be at least partially inserted in an opening position. This means that the flap is protected in an open position and the ground coffee can be transferred directly from the chute to the filter holder. Preferably, in the closed position, the flap closes the chute and also the downwardly open receiving chamber, in particular in a steam-tight manner.

The flap is preferably essentially plate-shaped, with an elastic seal being provided on the outer circumference of the flap in accordance with the invention. This seal preferably has a flexible sealing lip which, in the closed position, provides a seal against a wall of the shaft.

The flap is preferably arranged in such a way that an underside of the flap in the closed position faces the outside of the chute in an open position, so that the area that comes into contact with steam during coffee brewing faces the outside and no coffee grounds can stick there. Preferably, the chute below the flap is designed to spread open, i.e. it is arranged inclined to the vertical, for example at an angle of between 20° and 60°, so that as little coffee grounds as possible adhere in this area of the chute when it falls through the chute.

The rotational movement of the flap in the opening direction can be limited by a stop, which is preferably formed on the flap and which cooperates with a wall of the shaft to prevent further rotation when the opening position is reached. Also, when the closed position is reached, a section of the flap can come into contact with a wall of the shaft to limit the rotational movement so that no additional stop elements need to be provided.

For ease of manufacture, the flap can have an integrally formed bearing to accommodate the axis, for example in the form of a sleeve-shaped bushing. The bearing mount can have a cross-section that deviates from the circular shape in order to be connected to the axis in a simple manner so that it cannot rotate.

For effective handling, the flap can be driven by a motor that is connected to the axis via a gearbox. The gearbox can be designed as a toothed gear, but can also have other gear elements.

For good guidance of the coffee grounds exiting the grinder, the chute between the grinder and the filter holder can be angled so that a chute is formed behind the grinder, which then leads into a vertical section of the chute.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a view of the coffee machine according to the invention;

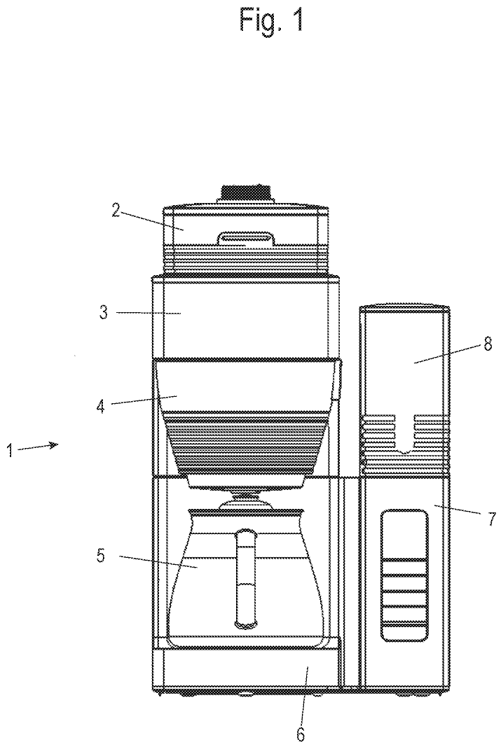

FIG. 2 shows a sectional view through the coffee machine in the area of the shaft with the flap open;

FIG. 3 shows a sectional view in the area of the shaft with the flap closed;

FIG. 4 shows a bottom view of the shaft in the closed position; and

FIGS. 5A and 5B show two detailed views of the flap with the axis.

### DETAILED DESCRIPTION OF PREFERRED EMBODIMENTS

A coffee machine 1 comprises a container 2 for storing coffee beans, which is arranged above a grinder 3. Below the grinder 3 is a filter holder 4 in which ground coffee for brewing coffee can be received, the brewed coffee being collectable in a jug 5 below the filter holder 4. The jug 5 is placed on a base 6 of a housing, which has a control unit 7 with a control system. A water tank 8 is detachably held on the housing, from which water can be conveyed by a pump to a heating device in order to then introduce the hot water into the filter holder 4 via a supply line.

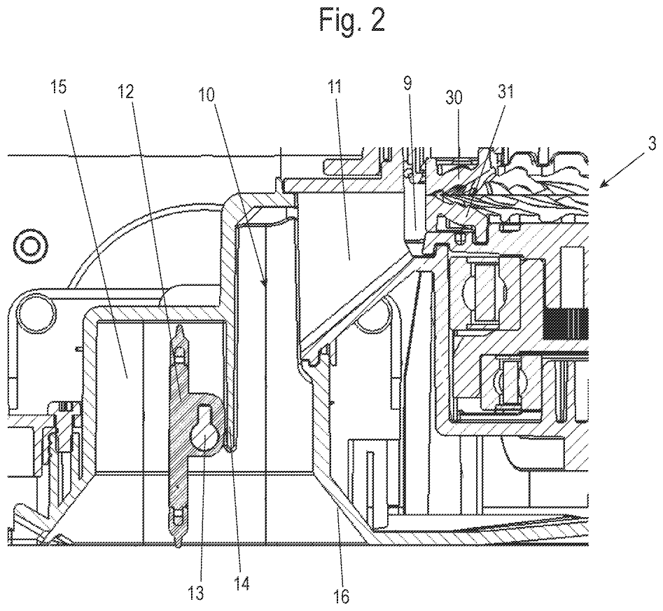

FIG. 2 shows a sectional view through the coffee machine 1, showing the area between the grinder 3 and the filter holder 4. The grinder 3 comprises two grinding discs 30 and 31, which are rotatable relative to each other and are used to grind coffee beans from the container 2. The grinder 3 has an outlet 9 which leads to a shaft 10. The shaft 10 is angular in shape and includes, adjacent to the outlet 9, a chute 11 and an adjoining vertical section. The shaft 10 may also have a different geometry for conveying the ground coffee from the grinder 3 into the filter holder 4.

A closing device with a rotatable flap 12 is arranged in the shaft 10, which flap is essentially plate-shaped and can be rotated about an axis 13. The axis 13 is located outside the shaft 10, which is bounded adjacent to the axis 13 by a wall 14 which is oriented substantially vertically. Adjacent to the shaft 10, a downwardly open chamber 15 is formed, into which the flap 12 can be at least partially inserted in an open position, so that the flap 12 is arranged in a protected manner in the open position.

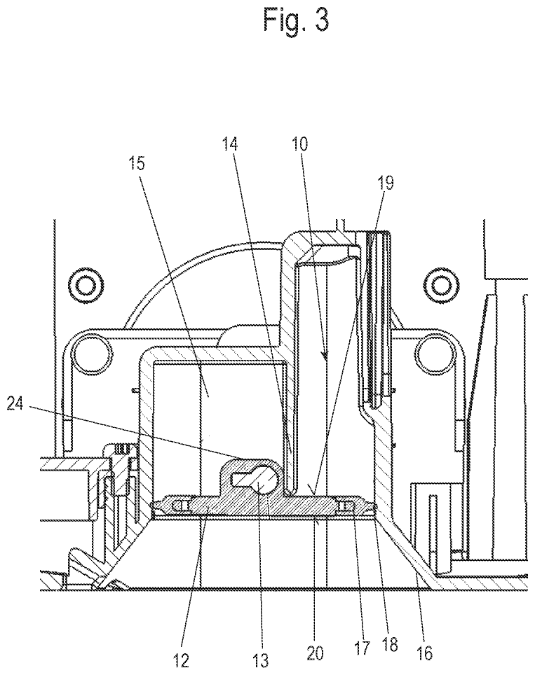

FIG. 3 shows a closed position of the flap 12. By rotating the flap 12 about the axis 13 by about 90°, the flap 12 has been moved from a vertical position to a horizontal position. An upper side 19 of a part of the flap 12 thereby seals the shaft 10 towards the upper side, while another part of the flap 12 seals the chamber 15. A bottom 20 of the flap 12 faces a space that water vapor can also reach when brewing coffee, so that the flap 12 prevents water vapor from entering the shaft 10 and the chamber 15.

The flap 12 is substantially plate-shaped and comprises a seal 17 at the outer periphery, which has a projecting bendable sealing lip 18 which can be placed against a wall in the region of the shaft 10. These abutment lines of the sealing lip 18 define a plane to which the axis 13 is oriented substantially parallel.

The area of the shaft 10 below the flap 12 is bounded by walls 16 which are splayed, for example at an angle of between 20° to 60° inclined to the vertical, so that coffee grounds falling down through the shaft 10 do not contact the walls 16, which may become coated with condensation during the brewing process.

A stop 24 is formed on the flap 12, which can strike against a wall 14 of the shaft 10 in the open position in order to limit the rotary movement of the flap 12. In this case, the wall 14 forms the partition between the shaft 10 and the receiving chamber 15, which is open towards the front, for receiving a part of the flap 12.

When the flap 12 is rotated in the closing direction, an upper side 19 of the flap 12 forms a stop and can come into contact with the lower end face of the wall 14, so that this rotational movement is also limited.

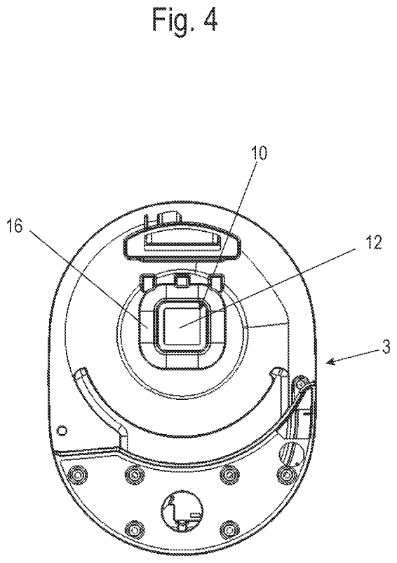

In FIG. 4, the area of the shaft 10 with a closed flap 12 is shown from below. Around the flap 12 are walls 16 which are arranged to spread open. The flap 12 is essentially square in plan view, but can also be rectangular or oval or have another geometry.

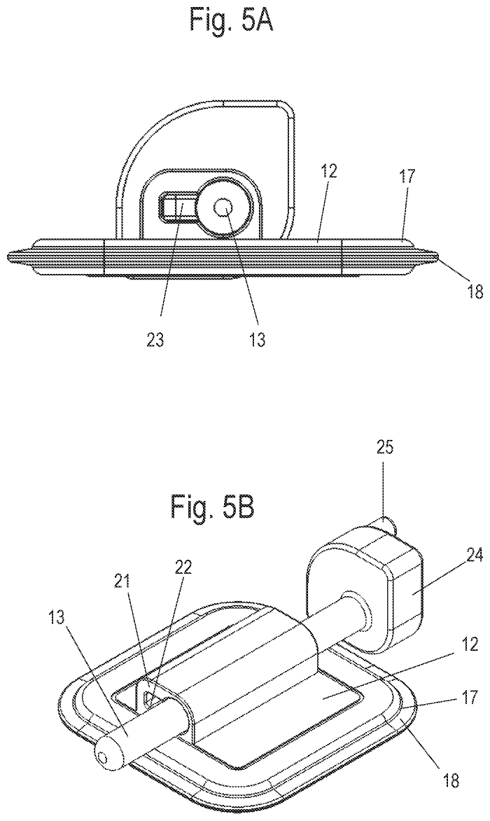

FIGS. 5A and 5B show the flap 12 with the axis 13 in detail. The substantially plate-shaped flap 12 has an integrally formed bearing 21 which serves for the passage of the pin-shaped axis 13. The bearing 21 does not have an exactly circular cross-section, but rather a chamber 22 projecting radially from the axis 13, into which a driver 23 is inserted, which is connected to or integrally formed with the axis 13. As a result, the flap 12 is connected to the shaft 10 in a rotationally fixed manner.

A block is further fixed or integrally formed on the axis 13 with the stop 24, on which a pin 25 is provided for connection to drive means. The pin 25 may, for example, be coupled by a gear with gears to a motor or other drive which is actuated by a control to move the flap 12 to the open position when coffee beans are ground by the grinder 3 and then to the closed position prior to the brewing operation.

In the illustrated embodiment, the axis 13 is arranged substantially centrally on the flap 12. It is also possible to arrange the flap 12 asymmetrically relative to the axis 13 to reduce the size of the downwardly open chamber 15. For example, the portion of the flap 12 projecting to the left side of the axis 13 in FIG. 3 could be shortened or omitted.

Although only a few embodiments of the present invention have been shown and described, it is to be understood that many changes and modifications may be made thereunto without departing from the spirit and scope of the invention.

### LIST OF REFERENCE SIGNS

1 Coffee machine
2 Container
3 Grinder
4 Filter holder
5 Jug
6 Base
7 Control unit
8 Water tank
9 Outlet
10 Shaft
11 Chute
12 Flap
13 Axis
14 Wall
15 Chamber
16 Wall
17 Seal
18 Sealing lip
19 Upper side
20 Bottom
21 Bearing
22 Chamber
23 Driver
24 Stop
25 Pin
30 Grinding disc
31 Grinding disc

What is claimed is:

1. A coffee machine comprising:
a) a container configured for holding coffee beans;
b) a grinder configured for receiving coffee beans fed from the container;
c) a filter holder configured for receiving ground coffee from the grinder fed via a shaft;
d) a supply device configured for introducing hot water into the filter holder; and
e) a closing device with a rotatable flap, the flap being disposed in a shaft between the grinder and the filter holder, which flap is movable between an open and a closed position,
wherein the flap is rotatable about an axis substantially parallel to a plane of the flap, and wherein the flap has a seal disposed on an outer periphery of the flap.

2. The coffee machine according to claim 1, wherein the plane of the flap corresponds to a sealing plane in the closed position of the flap.

3. The coffee machine according to claim 1, wherein the flap in the closed position has an upper side arranged at least partially in the shaft and wherein the upper side of the flap in the open position forms a wall portion facing an inner side of the shaft.

4. The coffee machine according to claim 1, wherein the axis of the flap is arranged outside the shaft.

5. The coffee machine according to claim 1, wherein the flap is rotatable between the opening and closing positions at an angle between 60° to 120°.

6. The coffee machine according to claim 1, wherein the axis extends in a horizontal plane.

7. The coffee machine according to claim 1, wherein a downwardly open receiving chamber is formed next to the shaft, into which the flap is insertable in the open position.

8. The coffee machine according to claim 7, wherein the flap in the closed position closes the shaft and the downwardly open receiving chamber.

9. The coffee machine according to claim 1, wherein the flap, in the closed position, has an underside which, in the open position, faces the outside of the shaft.

10. The coffee machine according to claim 1, wherein the shaft below the flap is designed to spread open.

11. The coffee machine according to claim 1, wherein a stop is formed on the flap, which stop is configured to be placed against a wall of the shaft.

12. The coffee machine according to claim 1, wherein an integrally formed bearing for receiving the axis is formed on the flap.

13. The coffee machine according to claim 1, wherein the seal has an outwardly projecting flexible sealing lip.

14. The coffee machine according to claim 1, wherein the flap is rotatable by means of a motor which is connected to the axis of the flap by means of a gear.

15. The coffee machine according to claim 1, wherein the shaft between the grinder and the filter holder is angular.
